(19) United States
(12) Patent Application Publication
(10) Pub. No.: US 2015/0271326 A1
(43) Pub. Date: Sep. 24, 2015

(54) SYSTEM AND METHOD FOR PROCESSING CALLS TO AN INVALID CALLED-TO NUMBER

(71) Applicant: 4XX, L.L.C., Higley, AZ (US)

(72) Inventors: Stephen J. Matlock, Higley, AZ (US); Federico Alves, Clearwater, FL (US)

(73) Assignee: 4XX, L.L.C., Higley, AZ (US)

(21) Appl. No.: 14/561,812

(22) Filed: Dec. 5, 2014

Related U.S. Application Data
(60) Provisional application No. 61/932,090, filed on Jan. 27, 2014.

(51) Int. Cl. H04M 3/436; G06Q 30/02

(52) U.S. Cl. CPC H04M 3/436; G06Q 30/0251; G06Q 30/0261; G06Q 30/0275

(57) ABSTRACT

A system for processing a call initiated at a calling terminal includes a call-screening processor within a central office network switch, wherein the network switch is in communication with the calling terminal, and an intercept service processor in communication with the call-screening processor via the network switch. Methodology executed within the system entails determining that the call is directed to an invalid called-to number, ascertaining characteristics associated with the call, and developing a call profile for the call based upon the characteristics. A targeted message is selected in response to the call profile and the targeted message is presented to a caller via the calling terminal.

### TECHNICAL FIELD OF THE INVENTION

The present invention relates generally to processing telephone calls. More specifically, the present invention relates to processing telephone calls directed to an invalid called-to number.

### BACKGROUND OF THE INVENTION

Traditional intercept telephony systems play an intercept message to a caller when a telephone call directed to an individual or business cannot be completed. A call might not be able to be completed for any of a number of reasons such as, for example, local congestion, disconnection of a dialed telephone number, or network problems. The intercept message played to the caller is traditionally limited to reporting an inability to complete the call. The intercept message played to the caller may be, for example, “The number you dialed is no longer in service. Please hang up, check the number, and try again.”

This type of intercept message is generally of no practical utility to the caller. After hearing the intercept message, the caller is typically left to his or her own ingenuity to find, for example, another business that provides the desired goods or services. In an attempt to identify alternatives, the caller may utilize directory service, search the Internet, or rely on other resources. In many cases, the caller may abandon the pursuit entirely.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, the Figures are not necessarily drawn to scale, and:

FIG. 1 shows a block diagram of a telephony network that includes an intercept service system in accordance with an embodiment;

FIG. 2 shows a flowchart of a call management process executed by the intercept service system within the telephony network;

FIG. 3 shows a table of call characteristics that may be ascertained in accordance with the call management process;

FIG. 4 shows a table of a call profile developed in response to the call characteristics;

FIG. 5 shows a table of configurable criteria that may be utilized to select a targeted message;

FIG. 6 shows a flowchart of a targeted message selection process; and

FIG. 7 shows an exemplary targeted message that may be presented to a caller in accordance with the call management process.

### DETAILED DESCRIPTION

Embodiments of the invention entail a system and method for processing a call directed to an invalid called-to telephone number. In various embodiments, the system and method may be operable to present a targeted message, such as an advertisement, to a caller based at least in part on characteristics of the call such as, for example, the caller's location and characteristics of the called-to telephone number. Accordingly, the system and method can provide useful information to the caller. Additionally, the system and method can provide revenue-generating opportunities to telecommunications carriers that provide targeted messaging via the system and method.

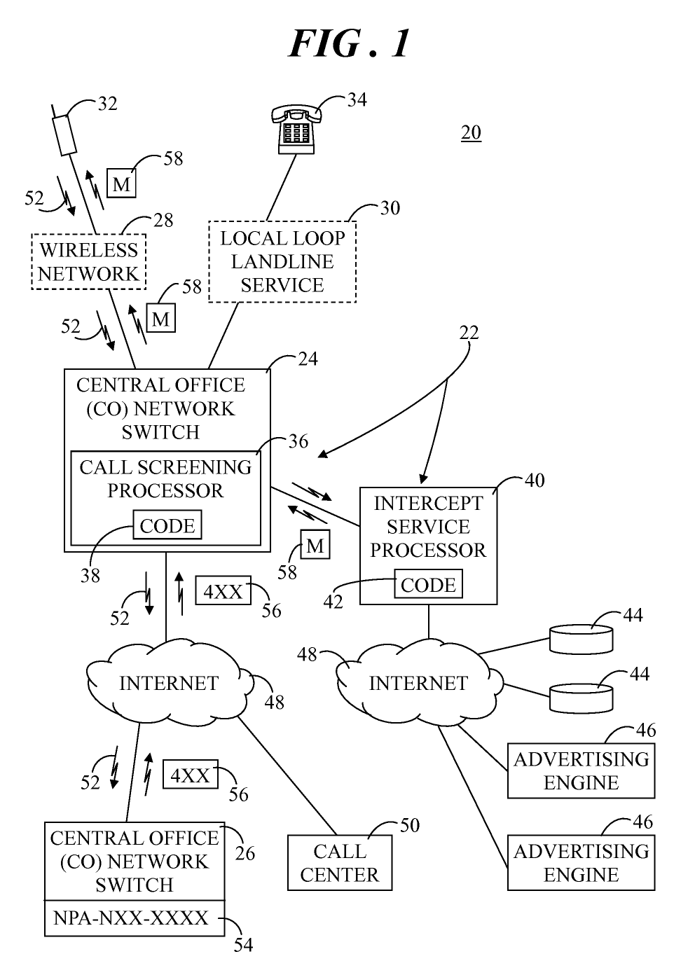

FIG. 1 shows a block diagram of a telephony network 20 that includes an intercept service system 22 in accordance with an embodiment. Telephony network 20 generally includes central office (CO) network switches 24, 26 (only two of which are shown), at least one wireless carrier network 28, and at least one local loop landline service 30. In general, CO network switches 24, 26 can receive calls from wireless devices 32 (one shown) via wireless carrier network 28 and/or can receive calls from landline devices 34 (one shown) via local loop landline service 30. Per convention, CO network switches 24, 26 include a network switch, a call-distributer service module, and other hardware and software systems (not shown) for processing calls.

In accordance with an embodiment, intercept service system 22 within telephony network 20 includes a call-screening processor 36 within at least one of CO network switches 24, 26. For illustrative purposes, call-screening processor 36 resides within CO network switch 24. However, it should be understood that call-screening processor 36 can reside within a plurality of CO network switches. Call-screening processor 36 is configured to execute call-screening code 38 stored in association with processor 36. Intercept service system 22 further includes an intercept service processor 40 configured to execute intercept service code 42 stored in association with processor 40. Intercept service processor 40 can have access to one or more intercept service databases 44 and one or more advertising engine processors 46 via, for example, the Internet 48. A call center 50 may additionally be accessed in accordance with methodology executed via intercept service system 22 and discussed below.

For exemplary purposes, wireless device 32 is shown originating a call, represented by an arrow 52. Call 52 is received via wireless network at CO network switch 24, referred to hereinafter as an originating network switch 24, for processing. Originating network switch 24 forwards it via, for example, Internet 48 to CO network switch 26, referred to hereinafter as a receiving network switch 26. Receiving network switch 26 may identify call 52 is being directed to an invalid called-to number 54. Thus, call 52 cannot be completed. Call 52 might not be able to be completed, for example, due to disconnection of the dialed number. This dialed number is referred to herein as invalid called-to number 54.

A Session Initiation protocol (SIP) is a signaling protocol commonly implemented for controlling communication sessions such as Voice over IP telephone calls. SIP is based around request/response transactions. By way of example, originating network switch 24 may send a three-digit integer “invite” code to receiving network switch 26 to initiate a call. Receiving network switch 26 must send a response code back to originating network switch 24. The response code can be a three-digit integer “OK” code indicating that the request was successful, a circuit can be opened, and billing can be opened between the call originating device and the call receiving device. When the dialed number is invalid called-to number 54, receiving network switch 26 will return a three-digit “client failure” response code to originating network switch 24. This response code, referred to herein as a failure code 56, is typically a four hundred series code and is generally represented in FIG. 1 by 4XX.

Accordingly, when call 52 is directed to invalid called-to number 54, receiving network switch 26 will return failure code 56 to originating network switch 24. Once originating network switch 24 receives failure code 56 from receiving network switch 26, originating network switch 24 can determine if invalid called-to number 54 is eligible for intercept treatment. Intercept treatment refers to procedures that may be enacted when call 52 to an individual or business cannot be completed. Call 52 might not be able to be completed, for example, due to disconnection of the dialed number, i.e. invalid called-to number 54. In such a scenario, call 52 may be deemed eligible for intercept treatment. As will be discussed in greater detail below, intercept treatment may include, for example, presentation of a targeted message 58 to the caller. In an embodiment, targeted message 58 may include a targeted advertisement for the caller.

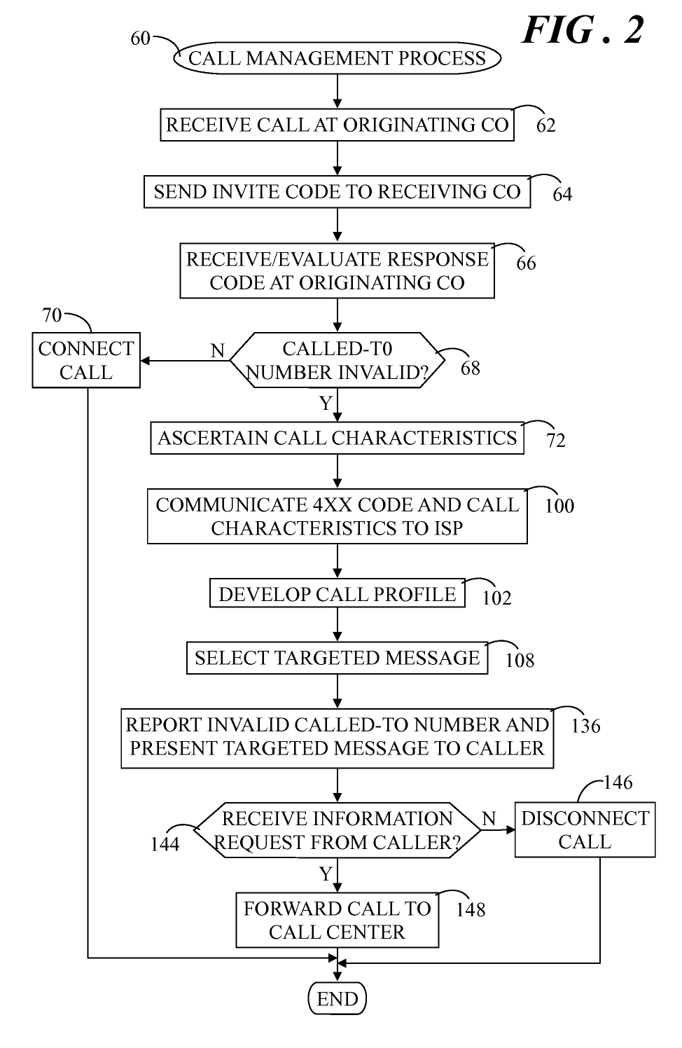

Referring to FIG. 2 in connection with FIG. 1, FIG. 2 shows a flowchart of a call management process 60 executed by intercept service system 22 within telephony network 20. Call management process 60 is executed by various elements within telephony network 20 including intercept service system 22 to connect calls to valid numbers and/or to provide intercept service to calls directed to invalid called-to numbers.

The execution of call management process 60 is initiated when a call is received (62) at an originating central office network switch, e.g., originating network switch 24. Upon receipt of the call, originating network switch 24 sends (64) an invite code to the receiving central office network switch, e.g., receiving network switch 26. Originating network switch 24 receives and evaluates (66) a response code from receiving network switch 26.

In response to the received response code, originating network switch 24 determines (68) whether the call is directed to an invalid called-to number. Per convention, when the call is not directed to an invalid called-to number, i.e., the called-to number is valid, the call is connected (70) per conventional processes. Thereafter, execution of call management process 60 for that particular call ends.

Upon occasion, originating network switch 24 receives failure code 56, typically a 4XX code, that is passed from receiving network switch 26 indicating that the call is directed to an invalid called-to number. This is represented in FIG. 1 as being call 52 directed to invalid called-to number 54. When originating network switch 24 determines (68) that the called-to number is invalid called-to number 54, call characteristics pertinent to the caller initiating call 52 and/or pertinent to invalid called-to number 54 are ascertained (72).

Referring concurrently to FIGS. 1-3, FIG. 3 shows a table 74 of call characteristics 76 that may be ascertained in accordance with task 72 of call management process 60. Call characteristics 76 can include caller characteristics 78 pertinent to the caller initiating call 52 and/or listing characteristics 80 pertinent to invalid called-to number 54.

In an embodiment, call screening processor 36 within originating network switch 24 is operable to derive caller characteristics 78, e.g., additional information about the caller, using the calling terminal, e.g., wireless device 32. Moreover, caller characteristics 78 can be ascertained independently of the caller. In various embodiments, caller characteristics 78 may include raw data and/or business analytics based on the raw data. In order to obtain at least a portion of the raw data, call screening processor 36 within originating network switch 24 may utilize various existing network attributes of call 52 and invalid called-to number 54. The network attributes include, for example, a caller's originating telephone number 82. Originating telephone number 82 includes, for example, an area code (NPA), a telephone exchange (NXX), and a line number (XXXX).

Call screening processor 36 may be further operable to develop or otherwise derive additional raw data. For example, call screening processor 36 may be operable to determine a date and time 84 of call 52, a station type 86, and location information 88 for the caller. In an embodiment, determining station type 86 may involve determining whether the calling terminal is mobile device 32, a pay phone, a hotel phone, or landline device 34 serving a residence or a business. Location information 88 may include, for example, a zip code, an address, coordinates, and other location identifiers. For example, when the calling terminal is mobile device 32, Global Positioning System (GPS) data, cellular-network data, or other data may be used to determine a location of mobile device 32.

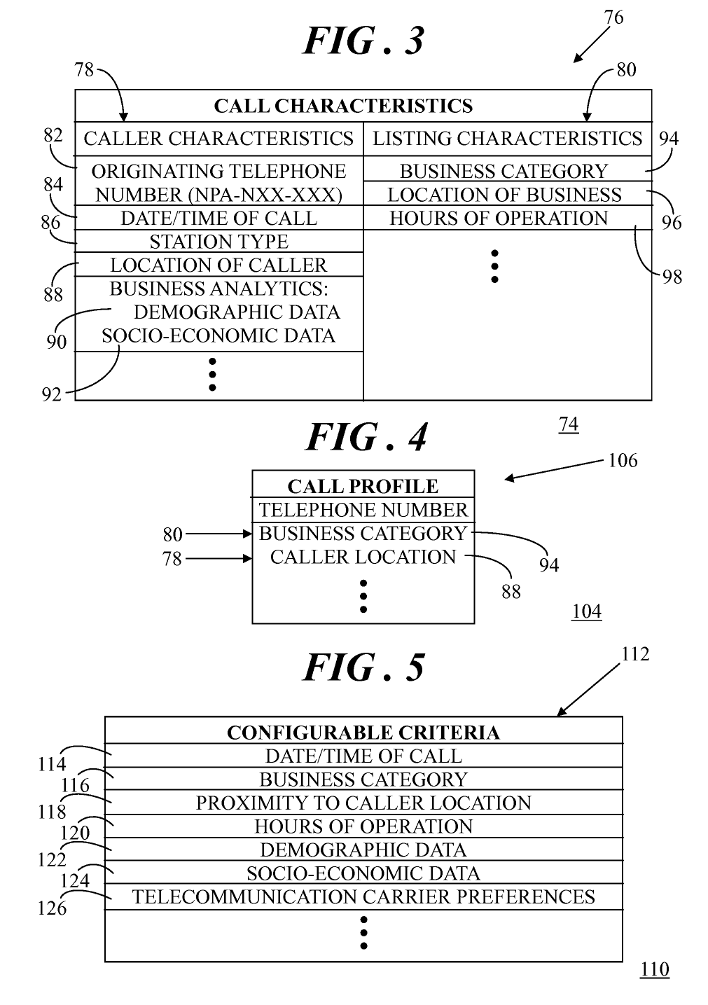

As noted above, caller characteristics 76 may additionally include business analytics based on the raw data. The business analytics may include, for example, demographic data 90 and/or socio-economic data 92 based on location information 88. It should be understood, that caller characteristics 78 may include additional information not specified herein, but represented by ellipses in FIG. 3.

In an embodiment, call screening processor 36 and/or intercept service processor 40 may be operable to ascertain (72) listing characteristics 80 of invalid called-to number 54 independently of the caller. In various embodiments, listing characteristics 80 may include a business category 94, location 96, hours of operation 98, and so forth of a business associated with invalid called-to number 54. By way of example, intercept service processor 40 may ascertain listing characteristics 80 via queries to intercept service databases 44. It should be understood, that listing characteristics 80 may include additional information not specified herein, but represented by ellipses in FIG. 3.

Referring back to FIGS. 1 and 2, in response to task 72, failure code 56 and call characteristics 76 are communicated (100) to intercept service processor 40, as needed. More specifically, call 52 may be held by originating network switch 24, while failure code 56 and details of call 52 and the caller, e.g., call characteristics 76, are communicated (100) to intercept service processor 40. In response to receipt of call characteristics 76, intercept service processor 40 develops (102) a call profile for call 52 based upon call characteristics 76.

Referring concurrently to FIGS. 1, 2, and 4, FIG. 4 shows a table 104 of a call profile 106 developed by intercept service processor 40 executing intercept service code 42 in response to the call characteristics 76. In an embodiment, call profile 106 contains information relating to, for example, “who is calling.” Call profile 106 includes, for example, a combination of one or more caller characteristics 78 (FIG. 3) and one or more listing characteristics 80 (FIG. 3). It should be recalled that intercept service processor 40 is operable to discover caller characteristics 78 from call screening processor 36 within originating network switch 24 and listing characteristics 80 from originating network switch 24 and/or via intercept service databases 44 independently of the caller. In the example presented in FIG. 4, call profile 106 for originating telephone number 82 includes at least one listing characteristic 80, namely, business category 94, and at least one caller characteristic 78, namely location of caller 88. It should be understood, that call profile 106 may include additional listing characteristics 80 and caller characteristics not specified herein, but represented by ellipses in FIG. 4.

Referring back to FIGS. 1 and 2, in response to task 102, targeted message 58 is selected (108) in response to call profile 106. In an embodiment, intercept service processor 40, executing intercept service code 42, may interact with at least one of intercept service databases 44 and/or advertising engine processors 46 to select and obtain targeted message 58. By way of example, intercept service processor 40 may select targeted message 58 based on configurable criteria.

Referring concurrently to FIGS. 1, 2, and 5, FIG. 5 shows a table 110 of configurable criteria 112 that may be utilized to select targeted message 58. Configurable criteria 112 may be any information that can be selected, prioritized, or otherwise specified to select targeted message 58 most suitable to the caller using the calling terminal, e.g., mobile device 32. Configurable criteria 112 may be selected from a group consisting of, for example, a date and time of call 114, business category 116, proximity to caller location 118, hours of operation 120, demographic data 122, socio-economic data 124, and telecommunication carrier preferences 126. It should be understood, that configurable criteria 112 may include additional information not specified herein, but represented by ellipses in FIG. 5.

Referring now to FIG. 6 in connection with selection task 108 (FIG. 2), FIG. 6 shows a flowchart of a targeted message selection process 128 that may be executed by intercept service processor 40 via intercept service code 42.

In an embodiment, intercept service processor 40 transmits (130) an advertising invitation to one or more sources of recorded advertising content. The invitation may include, for example, call profile 106 (FIG. 4) associated with call 52 (FIG. 1) to invalid called-to number 54 (FIG. 1) and other parameters. In response to transmitting (130) the advertising invitation, intercept service processor 40 receives (132) one or more advertising bids. In some embodiments, advertising engine processors 46 (FIG. 1) are generally responsible for delivering the advertising bids (i.e., potential targeted advertisements) to intercept service processor 40. In an embodiment, one or more advertising engine processors 46 may be, for example, a component of originating network switch 24 (FIG. 1) or an advertising service offered by an external provider. Thus, the multiple sources of recorded advertising content may respond to the advertising invitation via advertising engine processors 46 by supplying an advertising bid that includes a bid price and an advertisement based on call profile 106.

The bid price is a price that the source is willing to pay to present the advertisement to a caller with call profile 106. In a typical embodiment, the bid price is part of the advertising bid. Advertising bids may be pre-set based on bidding rules established by the advertisers on the plurality of advertising engine processors 46. Thus, various sources of advertising content may bid to present targeted message 58, in the form of an advertisement, to the caller. Advertising engine processors 46 may provide the targeted advertisements based at least in part on call profile 106. The targeted advertisement may be, for example, alternative business listings that may be presented to the caller or an advertising message (e.g., a recorded advertisement).

In response to receiving (132) the advertising bids, intercept service processor 40 selects (134) targeted message 58 (FIG. 1). In an embodiment, intercept service processor 40 is operable to select which alternative listing and/or advertising message to present to the caller based on configurable criteria 112 (FIG. 5), caller characteristics 78 (FIG. 3), listing characteristics 80 (FIG. 3), and availability of advertisers bidding for the opportunity to present targeted message 58, e.g., a targeted advertisement, to the caller. By way of example, if more than one advertising bid is received at task 132, intercept service processor 40 may select (134) the advertisement associated with the highest price bid as targeted message 58. Additionally, a list of alternative business listings and/or appropriate advertising messages may be derived based upon, for example, configurable criteria 112 (FIG. 5) such as date/time of call 114, business category 116 of invalid called-to number 54 (FIG. 1), proximity to caller location 118, hours of operation 120, demographic data 120, socio-economic data 122, and/or telecommunication carrier preferences 124 (see FIG. 5).

With reference back to FIGS. 1 and 2, once targeted message 58 has been selected (108), intercept service processor 40 is operable to present (136) targeted message 58 to the caller. In an embodiment, intercept service processor 40 is operable to report to the caller regarding invalid called-to number 54 and, as part of the report, present (136) targeted message 58. Thus, intercept service processor 40 may report to the caller that the invalid called-to number 54 is invalid and play a selected advertising message. In various embodiments, intercept service processor 40 may additionally generate various reports and other statistics (not shown) that may be used to measure system performance and enable billing and collection of advertising revenue.

In some embodiments, intercept service processor 40 may perform interactive-voice-response or text messaging functionality and collaborate with other components of originating network switch 24 to simply present targeted message 58 to the caller. Following presentation (136) of targeted message, execution of call management process 60 for that particular call may end as denoted by the dashed line following presenting operation (136). In alternative embodiments, presenting (136) may entail sending targeted message 58 that includes a request for response from the caller.

Referring concurrently to FIGS. 1, 2, and 7, FIG. 7 shows an exemplary targeted message 58 that may be presented to a caller in accordance with the presenting operation (136) of call management process 60. In this example, targeted message 58 includes a report 138 that the called telephone number, e.g., invalid called-to number 54 is invalid. Report 138 may express, for example, “The telephone number you have dialed is out of service.” However, it should be understood that report 138 can include any suitable verbal or text message indicating that the dialed number is invalid. Additionally, targeted message 58 may include a targeted advertisement 140 that includes a request for response 142 from the caller. In this example, targeted advertisement 140 that includes request for response 142 may express, “Joe's Hardware Store can alternatively serve your needs. Please press 1 to receive store location and hours.” However, it should be understood that targeted advertisement 140 can include any suitable verbal or text message for presentation to the caller.

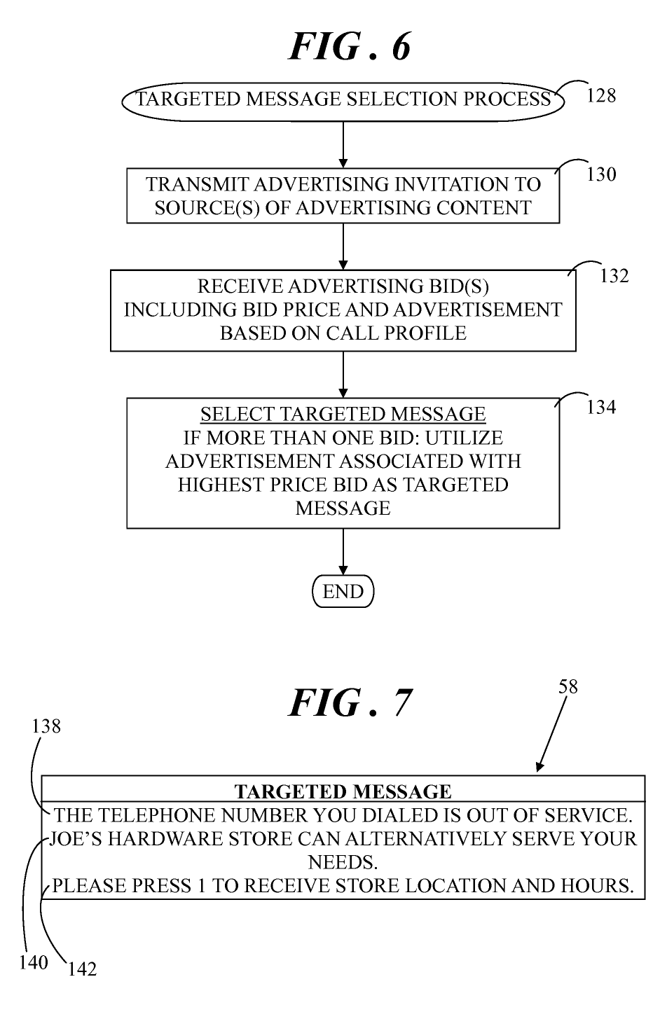

With reference back to FIGS. 1 and 2, in response to presenting (136) targeted message 58 that includes request for response 142 (FIG. 7), originating network switch 24 may continue to hold call 52 and intercept service processor 40 may wait for some predetermined period of time for receipt of an information request from the caller. When a determination (144) is eventually made that an information request was not received from the caller, the call is disconnected (146) per conventional processes. Thereafter, execution of call management process 60 for that particular call ends.

In some embodiments, when an information request is received (144) from the caller, call 52 may be forwarded (148) to call center 50 for further processing. In the illustrated example of FIG. 7, upon positive response from the caller (e.g., the caller presses 1 to receive additional information), intercept service provider 40 directs originating network switch 24 to pass call 52 via the internet 48 to the designated call center 50 for processing of the caller's information request. In some embodiments, the caller may hear a pre-recorded message. In other embodiments, the caller may speak to a live agent at call center 50.

Thus, various embodiments of a system and method for processing a call directed to an invalid called-to telephone number. More particularly, the system and method may be operable to present a targeted message, such as an advertisement, to a caller based at least in part on characteristics of the call such as, for example, the caller's location and characteristics of the called-to telephone number. Accordingly, the system and method can provide useful information to the caller. Additionally, the system and method can provide advertising revenue to those telecommunications carriers that provide targeted messaging via the system and method.

While the principles of the inventive subject matter have been described above in connection with specific system and methods, it is to be clearly understood that this description is made only by way of example and not as a limitation on the scope of the inventive subject matter. Further, the phraseology or terminology employed herein is for the purpose of description and not of limitation.

The foregoing description of specific embodiments reveals the general nature of the inventive subject matter sufficiently so that others can, by applying current knowledge, readily modify and/or adapt it for various applications without departing from the general concept. Therefore, such adaptations and modifications are within the meaning and range of equivalents of the disclosed embodiments. The inventive subject matter embraces all such alternatives, modifications, equivalents, and variations as fall within the spirit and broad scope of the appended claims.

What is claimed is:

1. A method for processing a call initiated at a calling terminal comprising:
determining that said call is directed to an invalid called-to number;
ascertaining characteristics associated with said call;
developing a call profile for said call based upon said characteristics;
selecting a targeted message in response to said call profile; and
presenting said targeted message to a caller via said calling terminal.

2. The method of claim 1 further comprising reporting to said caller that said call is directed to said invalid called-to number, wherein said reporting is performed concurrent with said presenting said targeted message.

3. The method of claim 1 further comprising:
receiving, at an intercept service, notification from a central office that is processing said call that said call is directed to said invalid called-to number; and
accessing, by said intercept service, a database of messages to select said targeted message from said database of messages.

4. The method of claim 1 further comprising determining a geographic location of said caller, wherein said selecting comprises selecting said target message based at least in part on said geographic location.

5. The method of claim 1 wherein:
said ascertaining comprises determining network attributes of said call and a telephone number associated with said called party from said characteristics; and
said selecting comprises selecting said target message based at least in part by said network attributes and said telephone number.

6. The method of claim 1 wherein said selecting comprises selecting said targeted message based upon configurable criteria, wherein said configurable criteria comprises at least one criterion selected from a group consisting of a business category, proximity to a geographic location of said caller, socioeconomic data associated with said geographic location, demographic data associated with said geographic location, hours of operation of a business, a date and time of said call, and preference of a telecommunications carrier associated with said call.

7. The method of claim 1 wherein said selecting comprises:
transmitting an advertising invitation to at least one source of advertising content;
receiving, from said at least one source of advertising content, at least one advertising bid in response to said transmitting, said at least one advertising bid including a bid price and an advertisement based at least in part upon said call profile; and
utilizing said advertisement as said targeted message.

8. The method of claim 7 wherein said at least one advertising bid comprises a plurality of advertising bids, and said selecting further comprises:
identifying one of said plurality of advertising bids having a highest bid price relative to said bid price of a remainder of said plurality of advertising bids; and
utilizing said advertisement associated with said one of said plurality of advertising bids having said highest bid price as said targeted message.

9. The method of claim 1 wherein said invalid called-to number is associated with a company that is no longer in business, and said targeted message comprises at least one of an alternative company listing and an advertising message.

10. The method of claim 1 wherein in response to said determining, said method further comprises:
receiving, at an intercept service, said characteristics from a central office through which said call is being processed;
performing said selecting at said intercept service; and
communicating said targeted message to said central office through which said call is being processed for presentation of said target message to said caller.

11. The method of claim 1 wherein said targeted message comprises a request for response from said caller, and said method further comprises:
following said presenting, receiving an information request from said caller in response to said request for response; and
forwarding said call to a call center associated with said information request for processing said information request received from said caller.

12. A system for processing a call initiated at a calling terminal comprising:
a call-screening processor within a central office (CO) network switch, said network switch being in communication with said calling terminal, wherein when said network switch determines that said call is directed to an invalid called-to number, said call-screening processor ascertains characteristics associated with said call; and
an intercept service processor in communication with said call-screening service processor, wherein when said intercept service processor receives notification from said call-screening processor that said call is directed to said invalid called-to number, said intercept service processor develops a call profile for said call based upon said characteristics, selects a targeted message in response to said call profile, and presents said targeted message to a caller via said calling terminal.

13. The system of claim 12 wherein when said targeted message is presented to said caller, said intercept service provider reports to said caller that said call is directed to said invalid called-to number.

14. The system of claim 12 wherein said characteristics include listing characteristics associated with said invalid called-to number, and said system further comprises at least one intercept service database containing said listing characteristics, and at least one of said call-screening processor and said intercept service processor is configured to access said at least one intercept service database to ascertain said listing characteristics.

15. The system of claim 12 wherein said characteristics include listing characteristics associated with said invalid called-to number, and at least one of said call-screening processor and said intercept service processor is configured to receive said listing characteristics independent of said caller from said CO network switch.

16. The system of claim 12 wherein said characteristics include caller characteristics associated with said caller, and said call-screening processor is configured to ascertain said caller characteristics independent of said caller using said calling terminal.

17. The system of claim 12 further comprising at least one advertising engine processor in communication with said intercept service processor, said advertising engine processor being configured to deliver said targeted message to said intercept service processor.

18. The system of claim 17 wherein said intercept service processor is configured to transmit an advertising invitation to at least one source of advertising content via said advertising engine processor, receive at least one advertising bid from said at least one advertising engine processor, wherein said at least one advertising bid includes a bid price and an advertisement, and utilize said advertisement as said targeted message.

19. A method for processing a call initiated at a calling terminal comprising:
determining that said call is directed to an invalid called-to number;
ascertaining characteristics associated with said call;
developing a call profile for said call based upon said characteristics;
selecting a targeted message in response to said call profile, wherein said selecting comprises:
transmitting an advertising invitation to at least one source of advertising content;
receiving, from said at least one source of advertising content, at least one advertising bid in response to said transmitting, said at least one advertising bid including a bid price and an advertisement based at least in part upon said call profile; and
utilizing said advertisement as said targeted message;
reporting to said caller that said call is directed to said invalid called-to number; and
presenting said advertisement to a caller via said calling terminal, wherein said reporting is performed concurrent with said presenting said targeted message.

20. The method of claim 19 wherein said advertisement comprises a request for response from said caller, and said method further comprises:
following said presenting, receiving an information request from said caller in response to said request for response; and
forwarding said call to a call center associated with said information request for processing said information request received from said caller.
